(19) United States
(12) Patent Application Publication
(10) Pub. No.: US 2008/0079625 A1
(43) Pub. Date: Apr. 3, 2008

(54) System and method for stereoscopic anomaly detection using microwave imaging

(76) Inventors: William Weems, San Jose, CA (US); Gregory S. Lee, Mountain View, CA (US); Robert C. Taber, Palo Alto, CA (US); Paul L. Corredoura, Redwood City, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/542,498

(22) Filed: Oct. 3, 2006

(51) Int. Cl. G01S 13/89; G01V 3/12; G01S 7/20

(52) U.S. Cl. 342/22; 342/180; 342/179

(57) ABSTRACT

A microwave imaging system for constructing a stereoscopic microwave image of an object includes an antenna array with a plurality of programmable antenna elements and a processor. Each of the antenna elements is capable of being programmed with a respective first direction coefficient to capture a first microwave image of the object from a first focal point on the array. In addition, each of the antenna elements is capable of being programmed with a respective second direction coefficient to capture a second microwave image of the object from a second focal point on the array. The processor constructs the stereoscopic microwave image from the first and second microwave images.

### CROSS-REFERENCE TO RELATED APPLICATIONS

This application is related by subject matter to U.S. application for patent Ser. No. 10/997,422, entitled “A Device for Reflecting Electromagnetic Radiation,” U.S. application for patent Ser. No. 10/997,583, entitled “Broadband Binary Phased Antenna,” both of which were filed on Nov. 24, 2004, and U.S. Pat. No. 6,965,340, entitled “System and Method for Security Inspection Using Microwave Imaging,” which issued on Nov. 15, 2005.

This application is further related by subject matter to U.S. application for patent Ser. No. 11/088,536, entitled “System and Method for Efficient, High-Resolution Microwave Imaging Using Complementary Transmit and Receive Beam Patterns,” U.S. application for patent Ser. No. 11/088,831, entitled “System and Method for Inspecting Transportable Items Using Microwave Imaging,” U.S. application for patent Ser. No. 11/089,298, entitled “System and Method for Pattern Design in Microwave Programmable Arrays,” U.S. application for patent Ser. No. 11/088,610, entitled “System and Method for Microwave Imaging Using an Interleaved Pattern in a Programmable Reflector Array,” and U.S. application for patent Ser. No. 11/088,830, entitled “System and Method for Minimizing Background Noise in a Microwave Image Using a Programmable Reflector Array” all of which were filed on Mar. 24, 2005.

This application is further related by subject matter to U.S. application for patent Ser. No. ______ (Attorney Docket No. 10050857-1), entitled “System and Method for Microwave Imaging with Suppressed Sidelobes Using Sparse Antenna Array,” which was filed on Jul. 14, 2005, U.S. application for patent Ser. No. ______ (Attorney Docket No. 10051094-1), entitled “System and Method for Microwave Imaging Using Programmable Transmission Array,” which was filed on Jun. 8, 2005 and U.S. application for patent Ser. No. ______ (Attorney Docket No. 10051409-1), entitled “Handheld Microwave Imaging Device” and Ser. No. ______ (Attorney Docket No. 10051410), entitled “System and Method for Standoff Microwave Imaging,” both of which were filed on Dec. 16, 2005.

### BACKGROUND OF THE INVENTION

In response to an increasing threat of terrorism, inspection of persons and other items for weapons and other types of contraband is becoming essential at security checkpoints, such as those found at airports, concerts, sporting events, courtrooms, federal buildings, schools and other types of public and private facilities potentially at risk from terrorist attacks. Conventional security inspection systems currently in place at security checkpoints include physical inspection, such as visual and/or tactile inspection, performed by security personnel, metal detectors and X-ray systems. However, physical inspection by security personnel is tedious, unreliable and invasive. In addition, metal detectors are prone to false alarms, and are not capable of detecting non-metallic objects, such as plastic or liquid explosives, plastic or ceramic handguns or knives and drugs. Furthermore, X-ray systems pose a health risk, particularly to those people who are repeatedly exposed to X-ray radiation, such as airport personnel.

As a result of the need for improved security inspection systems, various microwave imaging systems have been proposed as an alternative to existing systems. Microwave radiation is generally defined as electromagnetic radiation having wavelengths between radio waves and infrared waves. Since microwave radiation is non-ionizing, it poses no known health risks to people at moderate power levels. In addition, over the spectral band of microwave radiation, most dielectric materials, such as clothing, paper, plastic and leather are nearly transparent. Therefore, microwave imaging systems have the ability to penetrate clothing to image items concealed by clothing.

At present, there are several microwave imaging techniques available. For example, one technique uses an array of microwave detectors (hereinafter referred to as “antenna elements”) to capture either passive microwave radiation emitted by a target associated with the person or other object or reflected microwave radiation reflected from the target in response to active microwave illumination of the target. A two-dimensional or three-dimensional image of the person or other object is constructed by scanning the array of antenna elements with respect to the target's position and/or adjusting the frequency (or wavelength) of the microwave radiation being transmitted or detected.

Microwave imaging systems typically include transmit, receive and/or reflect antenna arrays for transmitting, receiving and/or reflecting microwave radiation to/from the object. Such antenna arrays can be constructed using traditional analog phased arrays or binary reflector arrays. In either case, the antenna array typically directs a beam of microwave radiation containing a number of individual microwave rays towards a point or area/volume in 3D space corresponding to a voxel or a plurality of voxels in an image of the object, referred to herein as a target. This is accomplished by programming each of the antenna elements in the array with a respective phase shift that allows the antenna element to modify the phase of a respective one of the microwave rays. The phase shift of each antenna element is selected to cause all of the individual microwave rays from each of the antenna elements to arrive at the target substantially in-phase. Examples of programmable antenna arrays are described in U.S. patent application Ser. No. 10/997,422, entitled “A Device for Reflecting Electromagnetic Radiation,” and Ser. No. 10/997,583, entitled “Broadband Binary Phased Antenna.”

The resulting microwave image of the object can be displayed as a two-dimensional (2D) or three-dimensional (3D) image to an operator. However, if contraband is positioned on a person or other object such that it appears as an integral part of the object, the operator may not detect the contraband in the 2D or 3D microwave image. In addition, in automatic threat detection systems, the system may not be able to positively identify areas which are not integral to the imaged object.

Therefore, what is needed is a microwave imaging system capable of detecting anomalies on the surface of the imaged object. In addition, what is needed is a microwave imaging system capable of displaying microwave images that enable an operator to observe anomalies on the surface of the imaged object.

### SUMMARY OF THE INVENTION

Embodiments of the present invention provide a microwave imaging system for constructing a stereoscopic microwave image of an object. The microwave imaging system includes an antenna array including a plurality of antenna elements and a processor. Each of the antenna elements is capable of being programmed with a respective first direction coefficient to direct microwave illumination from a first focal point on the array toward a target on the object and receive reflected microwave illumination from the target to capture a first microwave image of the object. In addition, each of the antenna elements is capable of being programmed with a respective second direction coefficient to direct microwave illumination from a second focal point on the array toward the target and receive reflected microwave illumination from the target to capture a second microwave image of the object.

The processor is operable to measure a respective intensity of the reflected microwave illumination for the first microwave image and the second microwave image to determine respective values of respective voxels within the first and second microwave images of the object. The processor is further operable to construct the stereoscopic microwave image of the object from the first and second captured microwave images.

In an exemplary embodiment, the antenna array includes a first set of said antenna elements arranged to direct a first transmit beam of microwave illumination from the first focal point toward the target and a second set of said antenna elements arranged to direct a second transmit beam of microwave illumination from the second focal point toward the target. In one embodiment, the first set of antenna elements is positioned on a first antenna array and the second set of antenna elements is positioned on a second antenna array. In another embodiment, the first set of antenna elements overlaps the second set of antenna elements on the array.

In a further embodiment, the processor is operable to create a parallax from the first microwave image and the second microwave image and to construct said stereoscopic microwave image using parallax information associated with the parallax, the first microwave image and the second microwave image. In still a further embodiment, the processor is operable to analyze the stereoscopic microwave image to determine spatial depth information associated with the object and to identify anomalies in the object using the spatial depth information.

Embodiments of the present invention further provide a method for constructing a stereoscopic microwave image. The method includes providing an antenna array including a plurality of antenna elements, programming each of the antenna elements with respective direction coefficients to capture a first microwave image of an object from a first focal point on the array, programming each of the antenna elements with respective additional direction coefficients to capture a second microwave image of the object from a second focal point on the array and constructing the stereoscopic microwave image from the first and second captured microwave images.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a schematic block diagram illustrating an exemplary microwave imaging system, in accordance with embodiments of the present invention;

FIG. 2 is a schematic diagram illustrating an exemplary operation of an exemplary reflector antenna array for use in the microwave imaging system of the present invention;

FIG. 3 is a schematic diagram illustrating an exemplary operation of an exemplary transmissive antenna array for use in the microwave imaging system of the present invention;

FIG. 4 is a cross-sectional view of an exemplary passive antenna element for use in a reflective antenna array, in accordance with embodiments of the present invention;

FIG. 5 is a schematic diagram illustrating an exemplary active antenna element for use in an active transmit/receive antenna array, in accordance with embodiments of the present invention;

FIG. 6 is a schematic diagram of an exemplary microwave imaging system for constructing a stereoscopic microwave image using a parallax, in accordance with embodiments of the present invention;

FIGS. 7A-7C illustrate the construction of a stereoscopic microwave image using multiple captured microwave images and parallax information associated with the captured microwave images, in accordance with embodiments of the present invention;

FIGS. 8A and 8B are schematic diagrams of an exemplary antenna array providing different focal points; and

FIG. 9 is a flow chart illustrating an exemplary process for constructing a stereoscopic microwave image of an object, in accordance with embodiments of the present invention.

### DETAILED DESCRIPTION OF THE EXEMPLARY EMBODIMENTS

As used herein, the terms microwave radiation and microwave illumination each refer to the band of electromagnetic radiation having wavelengths between 0.3 mm and 30 cm, corresponding to frequencies of about 1 GHz to about 1,000 GHz. Thus, the terms microwave radiation and microwave illumination each include traditional microwave radiation, as well as what is commonly known as millimeter wave radiation. In addition, as used herein, the term “microwave imaging system” refers to an imaging system operating in the microwave frequency range, and the resulting images obtained by the microwave imaging system are referred to herein as “microwave images.”

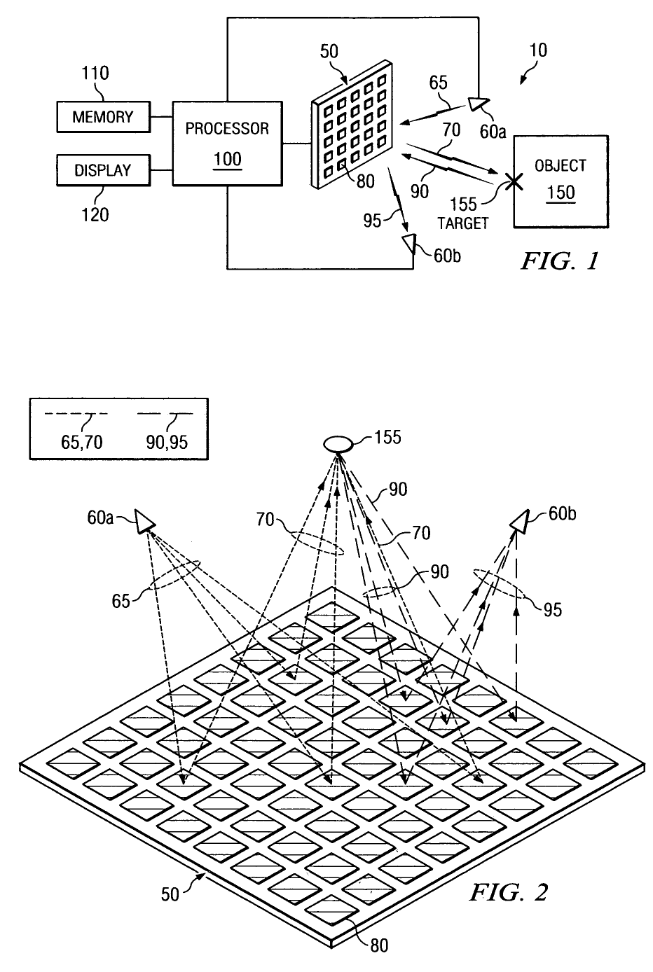

Referring now to FIG. 1, there is illustrated an exemplary microwave imaging system 10, in accordance with embodiments of the present invention. The microwave imaging system 10 can be used, for example, to provide ongoing surveillance to control a point-of-entry into a structure, monitor passers-by in an area (e.g., a hallway, a room or outside of a building) or to screen individual persons or other items of interest.

As can be seen in FIG. 1, the microwave imaging system 10 includes an imaging device in the form of an array 50 of antenna elements 80, each capable of transmitting, receiving and/or reflecting microwave radiation to capture a microwave image of an object 150 (e.g., a suitcase, human subject or other item of interest). Each of the antenna elements 80 is programmable with a respective transmit direction coefficient (e.g., a transmission coefficient or a reflection coefficient) to direct a beam of microwave radiation towards a target 155 on the object 150. As used herein, the term “target” refers to a point or area/volume in 3D space corresponding to a voxel or a plurality of voxels in a microwave image of the object 150. In addition, each of the antenna elements 80 is also programmable with an additional respective receive direction coefficient (e.g., a transmission coefficient or a reflection coefficient) to receive reflected microwave illumination reflected from the target 155. In an exemplary embodiment, the array 50 operates at a frequency that enables potentially millions of targets 155 in a volume to be scanned per second.

In one embodiment, the array 50 is a passive programmable reflector array composed of reflective or transmissive antenna elements 80 that reflect or transmit microwave radiation to and/or from one or more microwave antennas 60. For example, each of the reflective or transmissive antenna elements 80 can be programmed with a respective transmit direction coefficient to reflect or transmit microwave illumination emitted from one of the microwave antennas 60 towards the target. In addition, each of the reflective or transmissive antenna elements 80 can be programmed with an additional respective receive direction coefficient to reflect or transmit microwave illumination reflected from the target towards one of the microwave antennas 60. A single microwave antenna 60 can serve as both the source and receiver of microwave radiation, or separate microwave antennas 60 can be used for illuminating the array 50 and receiving reflected microwave illumination from the array 50, the latter being illustrated in FIG. 1.

As an example, as shown in FIG. 1, the antenna array 50 includes reflecting antenna elements 80, each capable of being programmed with a respective reflection coefficient to reflect microwave illumination. Therefore, when a microwave source 60a transmits a beam of microwave illumination 65 towards the antenna array 50, the reflecting antenna elements 80 can be programmed to reflect microwave illumination 70 towards the target 155 on the object 150 being imaged. In addition, when reflected microwave illumination 90 reflected from the target 155 is received at the antenna array 50, the reflecting antenna elements 80 can be programmed to reflect microwave illumination 95 towards the microwave receiver 60b.

In another embodiment, the array 50 is an active transmitter/receiver array composed of active antenna elements 80, each capable of producing and transmitting microwave radiation and each capable of receiving and capturing reflected microwave radiation. In this embodiment, microwave source/receive antennas 60 are not used, as the array 50 operates as the source of microwave radiation.

The microwave imaging system 10 further includes a processor 100, computer-readable medium 110 and a display 120. The processor 100 includes any hardware, software, firmware, or combination thereof for controlling the array 50 and processing the received microwave radiation reflected from the target 155 for use in constructing a microwave image of the object 150. For example, the processor 100 may include one or more microprocessors, microcontrollers, programmable logic devices, digital signal processors or other type of processing devices that are configured to execute instructions of a computer program, and one or more memories (e.g., cache memory) that store the instructions and other data used by the processor 100. The memory 110 includes any type of data storage device, including but not limited to, a hard drive, random access memory (RAM), read only memory (ROM), compact disc, floppy disc, ZIP® drive, tape drive, database or other type of storage device or storage medium.

The processor 100 operates to program the antenna array 50 to illuminate multiple targets 155 on the object 150. In exemplary embodiments, the processor 100 programs respective amplitude/phase delays or amplitude/phase shifts into each of the individual antenna elements 80 in the array 50 to illuminate each target 155 on the object 150. In addition, the processor 100 programs respective amplitude/phase delays or amplitude/phase shifts into each of the individual antenna elements 80 in the array 50 to receive reflected microwave illumination from each target 155 on the object 150. In embodiments using phase shifts, the programmed phase shifts can be either binary phase shifts, some other multiple number of phase shifts or continuous phase shifts.

The processor 100 is further capable of constructing a microwave image of the object 150 using the intensity of the reflected microwave radiation captured by the array 50 from each target 155 on the object 150. For example, in embodiments in which the array 50 is a reflector array, the microwave receiver 60b is capable of combining the reflected microwave radiation reflected from each antenna element 80 in the array 50 to produce a value of the effective intensity of the reflected microwave radiation at the target 155. The intensity value is passed to the processor 100, which uses the intensity value as the value of a pixel or voxel corresponding to the target 155 on the object 150. In other embodiments in which the reflected microwave radiation represents the intensity of an area/volume of voxels, for each microwave image of a target 155 (area/volume in 3D space), the processor 100 measures a Fourier transform component of the desired image of the object 150. The processor 100 performs an inverse Fourier transform using the measured Fourier transform components to produce the image of the object 150.

The resulting microwave image of the object 150 can be passed from the processor 100 to the display 120 to display the microwave image. In one embodiment, the display 120 is a two-dimensional display for displaying three-dimensional microwave images of the object 150 or one or more one-dimensional or two-dimensional microwave images of the object 150. In another embodiment, the display 120 is a three-dimensional display capable of displaying three-dimensional microwave images of the object 150.

FIG. 2 is a schematic diagram of a top view of an exemplary array 50 for reflecting microwave radiation, in accordance with embodiments of the present invention. In FIG. 2, a source beam 65 of microwave radiation transmitted from a microwave source 60a is received by various antenna elements 80 in the array 50. The microwave source 60a can be any source sufficient for illuminating the array 50, including, but not limited to, a point source, a horn antenna or any other type of antenna. The antenna elements 80 within the array 50 are each programmed with a respective phase-shift to direct a transmit beam 70 of reflected microwave radiation towards a target 155. The phase-shifts are selected to create positive (constructive) interference between all of the microwave rays within the beam of reflected microwave radiation 70 at the target 155. Ideally, the phase-shift of each of the antenna elements 80 is adjusted to provide the same phase delay for each microwave ray of the reflected microwave radiation 70 from the source (antenna elements 80) to the target 155.

In a similar manner, as shown in FIG. 2, a reflect beam 90 of microwave radiation reflected from the target 155 and received at the array 50 can be reflected as a receive beam 95 of reflected microwave radiation towards a microwave receiver 60b. Again, the phase-shifts are selected to create positive (constructive) interference between all of the microwave rays within the beam of reflected microwave radiation 90 at the microwave receiver 60b. Although the microwave receiver 60b is shown at a different spatial location than the microwave source 60a, it should be understood that in other embodiments, the microwave source 60a can be positioned in the same spatial location as the microwave receiver 60b as a separate antenna or as part of the microwave receiver 60b (e.g., a confocal imaging system).

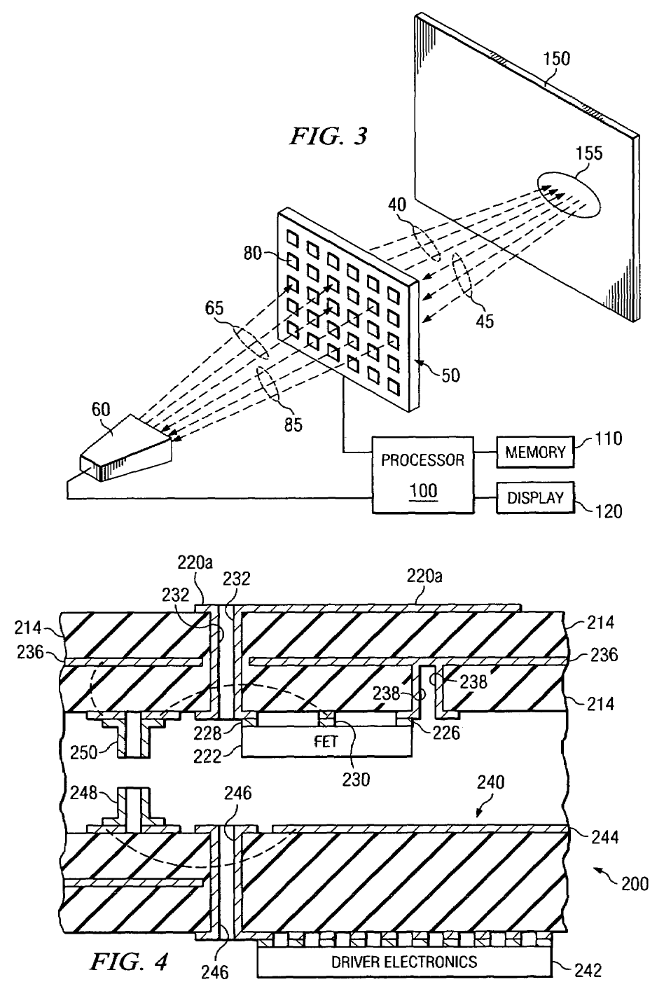

FIG. 3 is a schematic diagram of an exemplary microwave imaging system 10 using a transmissive array 50 for directing microwave illumination, in accordance with embodiments of the present invention. In FIG. 3, the microwave antenna (e.g., horn) 60 functions as both a microwave source and a microwave receiver. The horn 60 is located behind the array 50 to illuminate the array 50 from behind (i.e., the array 50 is situated between the target 155 and the horn 60).

In operation, microwave illumination 65 transmitted from horn 60 is received by various antenna elements 80 in the array 50. The antenna elements 80 in array 50 are each programmed with a respective transmission coefficient to direct transmitted microwave illumination 40 towards a target 155 on the object 150. The transmission coefficients are selected to create positive interference of the transmitted microwave illumination 40 from each of the antenna elements 80 at the target 155. Reflected microwave illumination 45 reflected from the target 155 is received by various antenna elements 80 in the array 50. The antenna elements 80 in array 50 are again each programmed with a respective transmission coefficient to direct transmitted microwave illumination 85 towards horn 60.

The horn 60 combines the transmitted microwave radiation 85 from each antenna element 80 in the array 50 to produce a value of the effective intensity of the reflected microwave radiation 45 at the target 155. The intensity value is passed to the processor 100, which uses the intensity value as the value of a pixel or voxel corresponding to the target 155 on the object 150. The processor 100 constructs a microwave image of the object 150 using the intensity of the reflected microwave radiation 45 captured by the array 50 from each target 155 on the object 150. The resulting microwave image of the object 150 can be passed from the processor 100 to the display 120 to display the microwave image. Although the microwave transmitter and receiver are shown in a confocal imaging configuration, it should be understood that in other embodiments, horn 60 can be implemented as two separate horns with different spatial locations.

FIG. 4 illustrates a cross-sectional view of a reflecting antenna element 200 (corresponding to antenna element 80 in FIGS. 1-3) that operates to reflect electromagnetic radiation with varying phase depending on the impedance state of the antenna element 200. The reflecting antenna element 200 includes an antenna (patch antenna 220a) and a non-ideal switching device (surface mounted field effect transistor “FET” 222).

The reflecting antenna element 200 is formed on and in a printed circuit board substrate 214 and includes the surface mounted FET 222, the patch antenna 220a, a drain via 232, a ground plane 236 and a source via 238. The surface mounted FET 222 is mounted on the opposite side of the printed circuit board substrate 214 as the planar patch antenna 220a and the ground plane 236 is located between the planar patch antenna 220a and the surface mounted FET 222. The drain via 232 connects the drain 228 of the surface mounted FET 222 to the planar patch antenna 220a and the source via 238 connects the source 226 of the surface mounted FET 222 to the ground plane 236.

In exemplary embodiments, the reflector antenna array is connected to a controller board 240 that includes driver electronics. The example controller board 240 depicted in FIG. 4 includes a ground plane 244, a drive signal via 246, and driver electronics 242. The controller board 240 also includes connectors 248 that are compatible with connectors 250 of the reflector antenna array. The connectors 248 and 250 of the two boards can be connected to each other, for example, using wave soldering. It should be understood that in other embodiments, the FET 222 can be surface mounted on the same side of the printed circuit board substrate 214 as the planar patch antenna 220a. Additionally, the driver electronics 242 can be soldered directly to the same printed circuit board in which the reflecting antenna element 200 is built.

The patch antenna element 220a functions to reflect with more or less phase shift depending on the impedance level of the reflecting antenna element 200. The reflecting antenna element 200 has an impedance characteristic that is a function of the antenna design parameters. Design parameters of antennas include but are not limited to, physical attributes such as the dielectric material of construction, the thickness of the dielectric material, shape of the antenna, length and width of the antenna, feed location, and thickness of the antenna metal layer.

The FET 230 (non-ideal switching device) changes the impedance state of the reflecting antenna element 200 by changing its resistive state. A low resistive state (e.g., a closed or “short” circuit) translates to a low impedance. Conversely, a high resistive state (e.g., an open circuit) translates to a high impedance. A switching device with ideal performance characteristics (referred to herein as an “ideal” switching device) produces effectively zero impedance (Z=0) when its resistance is at its lowest state and effectively infinite impedance (Z=∞) when its resistance is at its highest state. As described herein, a switching device is “on” when its impedance is at its lowest state (e.g., Zₒₙ=0) and “off” when its impedance is at its highest state (e.g., Z_{off}=∞). Because the on and off impedance states of an ideal switching device are effectively Zₒₙ=0 and Z_{off}=∞, an ideal switching device is able to provide the maximum phase shift without absorption of electromagnetic radiation between the on and off states. That is, the ideal switching device is able to provide switching between 0 and 180 degree phase states. In the case of an ideal switching device, maximum phase-amplitude performance can be achieved with an antenna that exhibits any finite non-zero impedance.

In contrast to an ideal switching device, a “non-ideal” switching device is a switching device that does not exhibit on and off impedance states of Zₒₙ=0 and Z_{off}=∞, respectively. Rather, the on and off impedance states of a non-ideal switching device are typically, for example, somewhere between 0<|Zₒₙ|<|Z_{off}|<∞. However, in some applications, the on and off impedance states may even be |Z_{off}|<=|Zₒₙ|. A non-ideal switching device may exhibit ideal impedance characteristics within certain frequency ranges (e.g., <10 GHz) and highly non-ideal impedance characteristics at other frequency ranges (e.g., >20 GHz).

Because the on and off impedance states of a non-ideal switching device are somewhere between Zₒₙ=0 and Z_{off}=∞, the non-ideal switching device does not necessarily provide the maximum phase state performance regardless of the impedance of the corresponding antenna, where maximum phase state performance involves switching between 0 and 180 degree phase states. In accordance with one embodiment of the invention, the reflecting antenna element 200 of FIG. 4 is designed to provide optimal phase performance, where the optimal phase state performance of a reflecting antenna element is the point at which the reflecting element is closest to switching between 0 and 180 degree phase-amplitude states. In an exemplary embodiment, to achieve optimal phase state performance, the antenna element 200 is configured as a function of the impedance of the non-ideal switching device (FET 230). For example, the antenna element 200 can be designed such that the impedance of the antenna element 200 is a function of impedance characteristics of the FET 230.

Further, the antenna element 200 is configured as a function of the impedance of the non-ideal switching device (FET 230) in the on state, Zₒₙ, and the impedance of the non-ideal switching device 230 in the off state, Z_{off}. In a particular embodiment, the phase state performance of the reflecting antenna element 200 is optimized when the antenna element 200 is configured such that the impedance of the antenna element 200 is conjugate to the square root of the impedance of the non-ideal switching device 230 when in the on and off impedance states, Zₒₙ and Z_{off}. Specifically, the impedance of the antenna element 200 is the complex conjugate of the geometric mean of the on and off impedance states, Zₒₙ and Z_{off}, of the corresponding non-ideal switching device 230. This relationship is represented as:

Zₐₙₜₑₙₙₐ*=\sqrt{ZₒₙZ_{off}}, (1)

where ( )* denotes a complex conjugate. The above-described relationship is derived using the well-known formula for the complex reflection coefficient between a source impedance and a load impedance. Choosing the source to be the antenna element 200 and the load to be the non-ideal switching device 230, the on-state reflection coefficient is set to be equal to the opposite of the off-state reflection coefficient to arrive at equation (1).

Designing the antenna element 200 to exhibit optimal phase-amplitude performance involves determining the on and off impedances, Zₒₙ and Z_{off} of the particular non-ideal switching device that is used in the reflecting antenna element 200 (in this case, FET 230). Design parameters of the antenna element 200 are then manipulated to produce an antenna element 200 with an impedance that matches the relationship expressed in equation (1) above. An antenna element 200 that satisfies equation (1) can be designed as long as Zₒₙ and Z_{off} are determined to be distinct values.

Another type of switching device, other than the surface mounted FET 230 shown in FIG. 4, that exhibits non-ideal impedance characteristics over the frequency band of interest is a surface mount diode. However, although surface mounted diodes exhibit improved impedance characteristics over the frequency band of interest compared to surface mounted FETs, surface mounted FETs are relatively inexpensive and can be individually packaged for use in reflector antenna array applications.

In a reflector antenna array that utilizes FETs as the non-ideal switching devices, the beam-scanning speed that can be achieved depends on a number of factors including signal-to-noise ratio, crosstalk, and switching time. In the case of a FET, the switching time depends on gate capacitance, drain-source capacitance, and channel resistance (i.e., drain-source resistance). The channel resistance is actually space-dependent as well as time-dependent. In order to minimize the switching time between impedance states, the drain of the FET is preferably DC-shorted at all times. The drain is preferably DC-shorted at all times because floating the drain presents a large off-state channel resistance as well as a large drain-source capacitance due to the huge parallel-plate area of the patch antenna. This implies that the antenna is preferably DC-shorted but one wishes the only “rf short” the antenna sees be at the source. Therefore, the additional antenna/drain short should be optimally located so as to minimally perturb the antenna.

It should be understood that other types of antennas can be used in the reflecting antenna element 200, instead of the patch antenna 220a. By way of example, but not limitation, other antenna types include dipole, monopole, loop, and dielectric resonator type antennas. In addition, in other embodiments, the reflecting antenna element 200 can be a continuous phase-shifted antenna element 200 by replacing the FETs 230 with variable capacitors (e.g., Barium Strontium Titanate (BST) capacitors). With the variable capacitor loaded patches, continuous phase shifting can be achieved for each antenna element 200, instead of the binary phase shifting produced by the FET loaded patches. Continuous phased arrays can be adjusted to provide any desired phase shift in order to steer a microwave beam towards any direction in a beam scanning pattern.

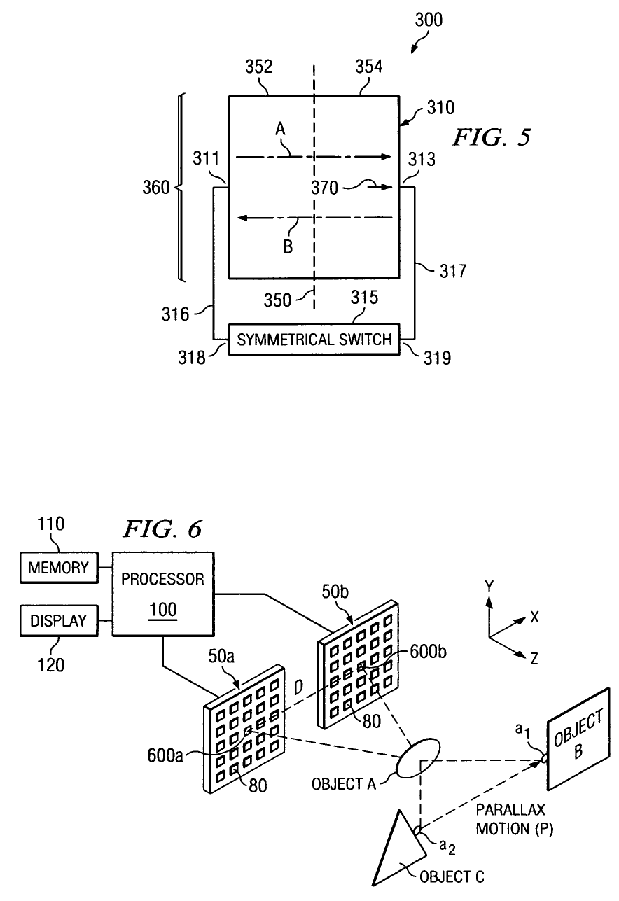

FIG. 5 illustrates an example of an active antenna element 300 (corresponding to an antenna element 80 in FIGS. 1-3) for use in an active transmit/receive or reflective array. The active antenna element 300 is a broadband binary phased antenna element including an antenna 310 connected to a respective switch 315. The switch 315 can be, for example, a single-pole double-throw (SPDT) switch or a double-pole double-throw (DPDT) switch. The operating state of the switch 315 controls the phase of the respective antenna element 300. For example, in a first operating state of the switch 315, the antenna element 300 may be in a first binary state (e.g., 0 degrees), while in a second operating state of the switch 315, the antenna element 300 may be in a second binary state (e.g., 180 degrees). The operating state of the switch 315 defines the terminal connections of the switch 315. For example, in the first operating state, terminal 318 may be in a closed (short circuit) position to connect feed line 316 between the antenna 310 and the switch 315, while terminal 319 may be in an open position. The operating state of each switch 315 is independently controlled by a control circuit (not shown) to individually set the phase of each antenna element 300.

As used herein, the term symmetric antenna 310 refers to an antenna that can be tapped or fed at either of two feed points 311 or 313 to create one of two opposite symmetric field distributions or electric currents. As shown in FIG. 5, the two opposite symmetric field distributions are created by using a symmetric antenna 310 that is symmetric in shape about a mirror axis 350 thereof. The mirror axis 350 passes through the antenna 310 to create two symmetrical sides 352 and 354. The feed points 311 and 313 are located on either side 352 and 354 of the mirror axis 350 of the antenna 310. In one embodiment, the feed points 311 and 313 are positioned on the antenna 310 substantially symmetrical about the mirror axis 350. For example, the mirror axis 350 can run parallel to one dimension 360 (e.g., length, width, height, etc.) of the antenna 310, and the feed points 311 and 313 can be positioned near a midpoint 370 of the dimension 360. In FIG. 5, the feed points 311 and 313 are shown positioned near a midpoint 370 of the antenna 310 on each side 352 and 354 of the mirror axis 350.

The symmetric antenna 310 is capable of producing two opposite symmetric field distributions, labeled A and B. The magnitude (e.g., power) of field distribution A is substantially identical to the magnitude of field distribution B, but the phase of field distribution A differs from the phase of field distribution B by 180 degrees. Thus, field distribution A resembles field distribution B at ±180° in the electrical cycle.

The symmetric antenna 310 is connected to the symmetric switch 315 via feed lines 316 and 317. Feed point 311 is connected to terminal 318 of the symmetric switch 315 via feed line 316, and feed point 313 is connected to terminal 319 of the symmetric switch 315 via feed line 317. As used herein, the term symmetric switch refers to either a SPDT or DPDT switch in which the two operating states of the switch are symmetric about the terminals 318 and 319.

For example, if in a first operating state of a SPDT switch, the impedance of a channel (termed channel α) is 10Ω and the impedance of another channel (termed channel β) is 1 kΩ, then in the second operating state of the SPDT switch, the impedance of channel α is 1 kΩ and the impedance of channel β is 10Ω. It should be understood that the channel impedances are not required to be perfect opens or shorts or even real. In addition, there may be crosstalk between the channels, as long as the crosstalk is state-symmetric. In general, a switch is symmetric if the S-parameter matrix of the switch is identical in the two operating states of the switch (e.g., between the two terminals 318 and 319).

Referring now to FIG. 6, in order to more effectively detect anomalies in the imaged object, multiple microwave images of the object can be captured from different focal points 600a and 600b on the array to construct a stereoscopic microwave image of the object. In one embodiment, as shown in FIG. 6, the different focal points 600a and 600b are provided using two separate arrays 50a and 50b, each including separate antenna elements 80. However, in other embodiments, the different focal points 600a and 600b can be achieved using different sub-panels (e.g., groups of contiguous antenna elements 80) on the array 50 or different sets of contiguous and/or non-contiguous individual antenna elements on the array 50.

Turning now to the details of FIG. 6, a stereoscopic microwave image of Object A is constructed by taking two separate microwave images of Object A, each from a different focal point 600a and 600b. In FIG. 6, the focal points 600a and 600b are created using two different sets of antenna elements 80. The first set of antenna elements 80 is located on a first array 50a, and the second set of antenna elements 80 is located on a second array 50b. Each of the antenna elements 80 in the first set is programmed with a respective transmit coefficient to create a first focal point 600a on the first array 50a. Likewise, each of the antenna elements 80 in the second set is programmed with a respective transmit coefficient to create a second focal point 600b on the second array 50b. In FIG. 6, the focal points 600a and 600b are positioned near the center of each array 50a and 50b. However, it should be understood that the focal points 600a and 600b may be located at any position on the arrays 50a and 50b, depending upon the individual programmed transmit coefficients of the antenna elements 80.

Regardless of the particular position of each focal point 600a and 600b on their respective arrays 50a and 50b, the focal points 600a and 600b are separated by a distance D, which is selected to create a parallax of Object A. As is understood in the art, a parallax is created by the apparent motion of an object against a background due to a change in position of an observer (i.e., a perspective shift). For example, when comparing an image of Object A taken from the first focal point 600a with an image of Object A taken from the second focal point 600a, Object A will appear to have moved, even though Object A has remained stationary. The distance D between the two focal points 600a and 600b in FIG. 6 is shown in the x-plane, and therefore, Object A will appear to have moved in the x-direction.

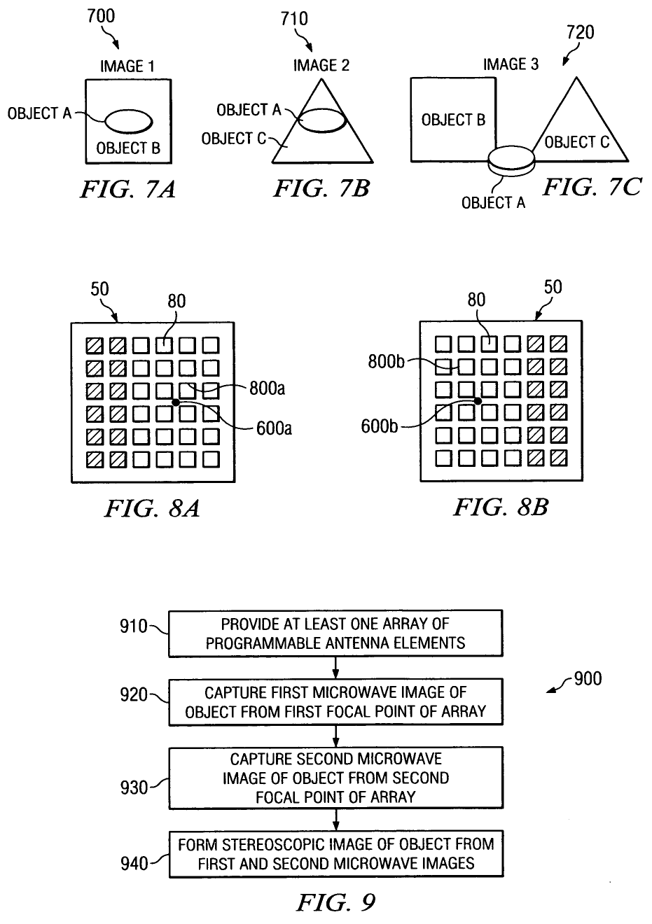

Referring now to FIGS. 7A and 7B, exemplary images 700 and 710 of Object A taken from each focal point 600a and 600b in FIG. 6 are illustrated. As can be seen from FIG. 6 and FIG. 7A, from the perspective of the first focal point 600a, Object A appears to be closer to Object B than Object C. In addition, as can be seen from FIG. 6 and FIG. 7B, from the perspective of the second focal point 600b, Object A appears to be closer to Object C than Object B. For example, in the image 700 taken by the first array 50a of antenna elements, Object A appears to be positioned in front of Object B, while in the image 710 taken by the second array 50b of antenna elements, Object A appears to be positioned in front of Object C. This apparent motion is illustrated in FIG. 6 as the parallax motion P. Thus, from the first image 700 to the second image 710, Object A appears to have moved from a position a₁ in front of Object B to a position a₂ in front of Object C.

Referring again to FIG. 6, in an exemplary operation, to create the parallax, the processor 100 programs the first set of antenna elements 80 on the first array 50a to direct a first transmit beam of microwave illumination from the first focal point 600a toward Object A to capture a first microwave image of Object A, and programs the second set of said antenna elements 80 on the second array 50b to direct a second transmit beam of microwave illumination from the second focal point 600b toward Object A to capture a second microwave image of Object A. From the first and second microwave images of Object A, the processor 100 is able to create a parallax of Object A. Using parallax information, such as the distance D between the two focal points 600a and 600b, the first microwave image and the second microwave image, the processor 100 is further able to construct a stereoscopic microwave image of Objects A, B and C. The stereoscopic microwave image can be stored in the memory 110 for subsequent automatic and/or human analysis and/or displayed on the display 120 to a human operator.

For example, referring to FIGS. 7A-7C, assuming FIG. 7A represents the first microwave image 700 taken from the first focal point 600a and FIG. 7B represents the second microwave image 710 taken from the second focal point 600b, FIG. 7C illustrates an exemplary stereoscopic microwave image 720 constructed using the two microwave images 700 and 710 and parallax information associated with the parallax created by the different images 700 and 710. As can be seen in FIG. 7C, the stereoscopic microwave image 720 is a 3D rendering of Objects A, B and C, which can be used to detect anomalies in the objects.

For example, referring again to FIG. 6, the processor 100 and/or a human operator can analyze the stereoscopic microwave image 720 to realize spatial depth information pertaining to Objects A, B and C, which can be used to make spatial connections between Objects A, B and C that might not otherwise be apparent with a single microwave image. In general, the stereoscopic microwave image enables the processor 100 and/or a human operator to discern between information that is an integral part of the object(s) being imaged and any anomalies therein. For example, the processor 100 can analyze the stereoscopic microwave image 720 to determine whether one object formed of Objects A, B and C is being imaged or multiple objects separate from one another, as shown, are being imaged. In an exemplary scenario, the stereoscopic microwave image can enable the processor 100 or an operator to detect contraband (e.g., a knife) taped to the chest of a human subject under that subject's clothes.

FIGS. 8A and 8B are schematic diagrams of an exemplary antenna array 50 providing different focal points 600a and 600b using different sets of individual antenna elements 80 on the same array 50. In FIGS. 8A and 8B, the diagonally-striped antenna elements are in an OFF state (i.e., not programmed with any coefficients), while the other antenna elements free of any markings are in an ON state (i.e., programmed with a direction coefficient). As can be seen in FIGS. 8A and 8B, the set of antenna elements 80 in an ON state in FIG. 8A is different from the set of antenna elements 80 in an ON state in FIG. 8B, thereby creating a different focal point 600a in FIG. 8A from the focal point 600b created in FIG. 8B. In an exemplary operation, the first set of antenna elements in FIG. 8A is programmed to create the first focal point 600a and capture the first microwave image, and subsequently, the second set of antenna elements is programmed to create the second focal point 600b and capture the second microwave image. Thus, the two microwave images are captured in a sequential manner.

Although there is overlap between the sets of ON antenna elements in FIGS. 8A and 8B, in other embodiments, the antenna elements 80 can be divided such that there is no overlap between the two sets. For example, in other embodiments, the array 50 can be divided into two or more sub-panels of contiguous antenna elements, each operating independent of one another to simultaneously create the two focal points 600a and 600b, and therefore, simultaneously capture the first and second microwave images. In addition, in still other embodiments, the separate focal points 600a and 600b can be created using separate single antenna elements 80 in the array 50.

FIG. 9 is a flow chart illustrating an exemplary process for constructing a stereoscopic microwave image of an object, in accordance with embodiments of the present invention. Initially, at block 910, at least one array of programmable antenna elements is provided for imaging an object. At block 920, each of the antenna elements is programmed with a respective direction coefficient to capture a first microwave image of an object from a first focal point on the array. At block 930, each of the antenna elements is programmed with a respective additional direction coefficient to capture a second microwave image of the object from a second focal point on the array. The first and second microwave images may be captured sequentially or substantially simultaneously depending on the configuration of the array(s).

At block 940, a stereoscopic microwave image of the object is formed from the first and second microwave images. For example, in one embodiment, a parallax of the object can be created from the different focal points, and using the parallax information, along with the first and second microwave images, the stereoscopic microwave image can be constructed. The stereoscopic microwave image may be used, for example, to detect anomalies in the imaged object.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

We claim:

1. A microwave imaging system, comprising:
an antenna array including a plurality of antenna elements, each capable of being programmed with a respective first transmit direction coefficient to direct microwave illumination from a first focal point on said array toward a target on an object and a respective first receive direction coefficient to receive reflected microwave illumination from said target to capture a first microwave image of said object and each capable of being programmed with a respective second transmit direction coefficient to direct microwave illumination from a second focal point on said array toward said target and a respective second receive direction coefficient to receive reflected microwave illumination from said target to capture a second microwave image of said object; and
a processor operable to measure a respective intensity of said reflected microwave illumination for said first microwave image and said second microwave image to determine respective values of respective voxels within said first and second microwave images of said object, and wherein said processor is further operable to construct a stereoscopic microwave image of said object from said first and second microwave images.

2. The system of claim 1, wherein each of said plurality of antenna elements are discrete phase-shifted antenna elements.

3. The system of claim 1, wherein each of said plurality of antenna elements is configured to receive microwave illumination from a microwave source and direct said microwave illumination toward said target based on said respective first and second transmit direction coefficients.

4. The system of claim 3, wherein each of said plurality of antenna elements is further configured to receive said reflected microwave illumination reflected from said target and direct said reflected microwave illumination towards a microwave receiver based on said respective first and second receive direction coefficients.

5. The system of claim 4, wherein said microwave source and said microwave receiver are co-located.

6. The system of claim 4, wherein each of said plurality of antenna elements is a reflecting antenna element, and wherein each said reflecting antenna element is configured to receive said microwave illumination from said microwave source and reflect said microwave illumination toward said target and receive said reflected microwave illumination from said target and reflect said reflected microwave illumination toward said microwave receiver.

7. The system of claim 4, wherein each of said plurality of antenna elements is a transmissive antenna element, and wherein each said transmissive antenna element is configured to receive said microwave illumination from said microwave source and transmit said microwave illumination toward said target and receive said reflected microwave illumination from said target and transmit said reflected microwave illumination toward said microwave receiver.

8. The system of claim 1, wherein each of said plurality of antenna elements are active transmit/receive antenna elements.

9. The system of claim 1, wherein said processor is operable to construct said first and second microwave images of said object by scanning multiple targets on said object to measure the respective intensity of reflected microwave illumination from each of said multiple targets.

10. The system of claim 1, further comprising:
a display operably coupled to said processor to display said stereoscopic microwave image.

11. The system of claim 10, wherein said antenna array includes:
a first set of said antenna elements arranged to direct a first transmit beam of microwave illumination from said first focal point toward said target, and
a second set of said antenna elements arranged to direct a second transmit beam of microwave illumination from said second focal point toward said target.

12. The system of claim 11, wherein said first set of antenna elements is positioned on a first antenna array and said second set of antenna elements is positioned on a second antenna array.

13. The system of claim 11, wherein said first set of antenna elements overlaps said second set of antenna elements on said array.

14. The system of claim 1, wherein said processor is further operable to create a parallax from said first microwave image and said second microwave image and to construct said stereoscopic microwave image using parallax information associated with said parallax, said first microwave image and said second microwave image.

15. The system of claim 14, wherein said processor is further operable to analyze said stereoscopic microwave image to determine spatial depth information associated with said object and identify anomalies in said object using said spatial depth information.

16. A method for constructing a stereoscopic microwave image, comprising:
providing an antenna array including a plurality of antenna elements;
programming each of said antenna elements with respective direction coefficients to capture a first microwave image of an object from a first focal point on said array;
programming each of said antenna elements with respective additional direction coefficients to capture a second microwave image of said object from a second focal point on said array; and
constructing said stereoscopic microwave image from said first and second microwave images.

17. The method of claim 16, wherein each said programming includes:
programming each of said antenna elements with a respective transmit direction coefficient to direct microwave illumination toward a target on said object;
programming each of said antenna elements with a respective receive direction coefficient to receive reflected microwave illumination reflected from the target; and
measuring an intensity of said reflected microwave illumination to determine a value of a voxel within a microwave image of said object.

18. The method of claim 17, wherein said providing said plurality of antenna elements includes:
providing a first set of said antenna elements arranged to direct a first transmit beam of microwave illumination from said first focal point toward said target, and
providing a second set of said antenna elements arranged to direct a second transmit beam of microwave illumination from said second focal point toward said target.

19. The method of claim 18, wherein said providing said plurality of antenna elements includes:
providing said first set of antenna elements on a first antenna array; and
providing said second set of antenna elements on a second antenna array.

20. The method of claim 19, wherein said providing said plurality of antenna elements further includes:
overlapping said first set of antenna elements and said second set of antenna elements.

21. The method of claim 16, further comprising:
displaying said stereoscopic microwave image of said object.

22. The method of claim 16, wherein said constructing said stereoscopic microwave image further comprises:
creating a parallax from said first microwave image and said second microwave image;
determining parallax information associated with said parallax; and
constructing said stereoscopic microwave image from said parallax information, said first microwave image and said second microwave image.

23. The method of claim 22, further comprising:
analyzing said stereoscopic microwave image to determine spatial depth information associated with said object; and
identifying anomalies in said object using said spatial depth information.

24. The method of claim 16, wherein said programming to capture said first microwave image and said programming to capture said second microwave image are performed substantially simultaneously.
